(19) United States
(12) Patent Application Publication
(10) Pub. No.: US 2008/0082254 A1
(43) Pub. Date: Apr. 3, 2008

(54) Route-assisted GPS location sensing via mobile device

(76) Inventors: Yka Huhtala, Helsinki (FI); Antti Sorvari, Itasalmi (FI); Markus Kahari, Helsinki (FI); Joonas Paalasmaa, Helsinki (FI)

Correspondence Address: Hollingsworth & Funk, LLC, Suite 125, 8009 34th Avenue South, Minneapolis, MN, 55425, US

(21) Appl. No.: 11/542,038

(22) Filed: Oct. 2, 2006

(51) Int. Cl. G01C 21/00

(52) U.S. Cl. 701/201

(57) ABSTRACT

Augmenting data sensed using a mobile device involves detecting, via a Global Positioning System (GPS) sensor, location data along a route while a user traverses the route. Predefined route data is provided that accurately reflects the locations of the route. The detected location data is augmented using the predefined route data via a mobile terminal capable of interfacing with the GPS sensor. A record of the traversal is created using the augmented location data.

### FIELD OF THE INVENTION

This invention relates in general to mobile devices, and more particularly to route assisted GPS positioning using mobile devices.

### BACKGROUND OF THE INVENTION

The ubiquity of cellular phones and similar mobile electronics has led to demands for ever more advanced features in these devices. Mobile phones are increasingly becoming multipurpose devices. For example, it is becoming much more common for mobile phones to include integrated devices such as cameras and alternate network interfaces (e.g., Bluetooth, Wi-Fi). Another feature that is expected to be included in many future mobile devices is the ability to determine location of the device.

Currently, location detection can be done on a coarse scale using wireless communication infrastructure, such as determining the approximate location based on the base station to which a device is connected. An even more useful form of location detection involves accessing Global Positioning System (GPS) satellites. The GPS system uses a constellation of more than two dozen satellites whose signals can be accessed by receivers on the earth. A terrestrial GPS receiver and associated logic is able to determine its latitude and longitude by triangulating the signals from three satellites. If signals from a fourth satellite can be received, the elevation can also be determined.

For some time, small GPS receiving devices have been available for such purposes as vehicle navigation, outdoor activities, location based gaming, etc. Typically, the GPS receiving devices are incorporated into a standalone device that, in its most basic form, provides a readout of current location. Where memory, displays, and processing power permit, such devices may also include other features, such as map overlays and the storage of waypoints.

As the costs of GPS sensors decrease, they are being incorporated into other devices as well. For example, modem cell phones and Personal Digital Assistants (PDAs) have become ubiquitous, general-purpose, mobile data processing devices. Given the mobility and always-on nature of such devices, it is quite natural that these devices will include GPS receivers and similar device so that the users can to take advantage of location-aware data-processing applications. For example, the currently available Nokia® N95 model cellular phone includes an integrated GPS sensor. The present disclosure describes improved location-aware methods and devices that provide advantages over existing implementations.

### SUMMARY OF THE INVENTION

To overcome limitations in the prior art described above, and to overcome other limitations that will become apparent upon reading and understanding the present specification, the present invention discloses a system, apparatus and method for augmenting measured location data using previously obtained route data. In accordance with one embodiment of the invention, a method involves detecting, via a Global Positioning System (GPS) sensor, location data along a route while a user traverses the route. Predefined route data is provided that accurately reflects the locations of the route. The detected location data is augmented using the predefined route data via a mobile terminal capable of interfacing with the GPS sensor. A record of the traversal is created using the augmented location data.

In more particular embodiments, the method involves using a point of the predefined route data as input to the GPS sensor to reduce the time required for the GPS sensor to fix coordinates when the user begins to traverse the route. In one arrangement augmenting the detected location data using the predefined route data involves filling in missing location data, correcting erroneous location data, and/or adding supplementary data to the detected location data. Adding the supplementary data to the detected location data may involve adding descriptive labels to the detected location data.

In other, more particular embodiments, the method involves detecting the location data via the mobile terminal while interfaced with the GPS sensor. In one arrangement, the predefined route data is created via the mobile terminal. Creating the predefined route data may involve measuring coordinates of the predefined route data using the GPS sensor, and in another configuration involves combining a plurality of location data sets previously measured on the route using the GPS sensor. In such a case, the method may also involve updating the predefined route data with the location data measured each time the route is traversed with the GPS sensor, which may also involve giving a higher weighting to the most recent location data measured while the route is traversed with the GPS sensor.

In other, more particular embodiments, the method involve providing the predefined route data after the location data is detected along the route using the GPS sensor. This may involve searching for the predefined route data via a network based on the location data using the location data as a search parameter. In another configuration, the detected location data is augmented while the route is being traversed.

In another embodiment of the invention, an apparatus includes a data interface capable of interfacing with a Global Positioning Satellite (GPS) sensor, a processor coupled to the data interface, and a memory coupled to the processor. The memory includes instructions that cause the processor to access location data detected along a route using the GPS sensor when a user traverses the route while carrying the GPS sensor and access predefined route data that accurately reflects the locations of the route. The instructions also cause the processor to augment the detected location data using the predefined route data and create a record of the traversal using the augmented location data.

In more particular embodiments, the memory includes instructions that further cause the processor to use a point of the predefined route data as input to the GPS sensor to reduce the time required for the GPS sensor to fix coordinates when the user begins to traverse the route. In one arrangement, the memory includes instructions that cause the processor to augment the detected location data using the predefined route data while the route is being traversed.

In other, more particular embodiments, the memory includes instructions that further cause the processor to create the predefined route data using coordinates previously measured using the GPS sensor. The memory may include instructions that cause the processor to combine a plurality of location data sets previously measured on the route using the GPS sensor to create the predefined route data, and to update the predefined route data with the location data measured each time the route is traversed with the GPS sensor. In one configuration, the processor gives a higher weighting to the most recent location data measured while the route is traversed with the GPS sensor when updating the predefined route data with the location data.

In other, more particular embodiments, the apparatus further includes a network interface capable of being coupled to a network, and the memory includes instructions that cause the processor to search for the predefined route data via the network based on the location data using the measured location data as a search parameter. In one configuration, the apparatus includes the GPS sensor, and in another configuration, the apparatus includes a cellular phone.

In another embodiment of the invention, a computer-readable medium has instructions stored which are executable by a data processing arrangement capable of interfacing with a Global Positioning System (GPS) sensor. The instructions are executable for performing steps that include 1) accessing location data that is detected along a route via the GPS sensor When a user traverses the route while carrying the GPS sensor; 2) accessing predefined route data that accurately reflects the locations of the route; 3) augmenting the detected location data using the predefined route data; and 4) creating a record of the traversal using the augmented location data.

In another embodiment of the invention, an apparatus includes means for accessing location data along a route, where the data is gathered via a GPS sensor when a user traverses the route. The apparatus also includes means for accessing predefined route data that accurately reflects the locations of the route, means for augmenting the detected location data using the predefined route data, and means for creating a record of the traversal using the augmented location data. The apparatus optionally includes means for using a point of the predefined route data as input to the GPS sensor to reduce the time required for the GPS sensor to fix coordinates when the user begins to traverse the route.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram of a system according to embodiments of the present invention;

FIGS. 2A and 2B are diagrams showing sequences of using route-assisted location sensing according to embodiments of the present invention;

FIGS. 2C-E are diagrams showing calculation of accurate route data using GPS measurements according to an embodiment of the invention;

FIG. 3 is a diagram illustrating an example of forming augmented location data according to an embodiment of the invention;

FIG. 4 is a diagram illustrating the use of historical augmented route data according to an embodiment of the invention;

FIG. 5 is a block diagram illustrating a representative mobile computing arrangement capable of carrying out operations in accordance with embodiments of the invention;

FIG. 6 is a block diagram illustrating an example computing structure suitable for providing location-aware services according to embodiments of the present invention;

FIG. 7 is a flowchart showing steps in route-assisted location sensing according to embodiments of the present invention; and

FIG. 8 is a flowchart showing steps for finding route information according to embodiments of the present invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention involves augmenting GPS data with predetermined location data so that data describing an actual route traveled can be modified to improve accuracy and fill in details that may not be determined based on GPS data alone. The term “augmenting” as used herein may refer to any combination of adding to, subtracting from, or changing all or part of measured data, generally to make the data more accurate and/or more useful. The concepts described herein can be applied to any type of mobile device application that involves sensing of location. One application in particular that may benefit from the present invention is the use of such devices in sports and fitness activities.

Sports and fitness activities can be monitored with location sensing (e.g., GPS assisted) devices in order to measure speed and distance. This speed and distance data is recorded, and can be used myriad ways by sports aficionados. For example, careful measurement of distances and times are important for runners and bicyclists who are trying to track progress and improvements as part of an exercise regime. Such measurements could be made without location sensing, such as using exercise tracks or pre-measured paths. However, such exercise paths can become boring for a frequent exerciser. Often, people desire to combine their exercise with the enjoyment of exploring new or infrequently visited areas, and this cannot be achieved by using the same exercise path.

Therefore, in order to allow a person to accurately track paths taken during exercise and similar activities, a GPS-assisted sports monitoring device can be used. The use of GPS location tracking enables the measurement of workout distance and speed, in addition to measurements performed with other sensors, such as for measuring heart rate, pedal power and workout time. However, there are some disadvantages in using GPS-assisted devices for these purposes. For example, when first determining its location (such as on power-up or reset), a GPS device that does not know its approximate current location (known as a “cold start”) may require several minutes to get a first fix. Therefore, in order to get any reading at all, the user may need to wait until the GPS device has gotten a location fix before beginning to exercise or otherwise traversing the intended path.

Even when the GPS device has gotten a fix, there may be several points along the way where satellite signals are lost and significant time elapses before another location fix can be determined. This is often the case when moving in terrain where the GPS device can be in a blind spot relative to satellites. In such a case, the location fix can be lost, or the quality of the fix may be low. This can happen quite frequently if the device is poorly located, e.g., when in the user's pocket, and/or when moving in urban canyons. Additions to the GPS constellation (known as “Galileo”) may be available in a number of years, and this problem may be somewhat reduced, because the increased total number of satellites (GPS+Galileo) helps the receiver to be able to pick up more satellites under more difficult conditions. However, even with the combined GPS+Galileo location fixes will be lost in difficult (but possibly common) situations, meaning that the problem will remain to be relevant even after improved satellite tracking is available.

Therefore, in many cases it may be assumed that some data may be lost during the times of dropout. In some cases, the lost data may linearly interpolated based on the last reading made before the location is re-acquired, but this can occasionally lead to significant errors. This type of error is particularly prevalent in winding paths and/or where the user's speed is relatively fast (e.g., riding a bicycle). Finally, GPS devices, like any measurement device, will have inherent measurement errors. This error is acceptable for many applications, but may still be troublesome at some scales, such as a small footpath or exercise route.

Because of inaccuracies in location measurements described above, route statistics such as route length, total ascent/descent and altitude profile may be somewhat inaccurate. In particular, absolute altitude and relative altitude changes are difficult to measure accurately with GPS devices. In practice this means that altitude information is often not taken into account when the total route/workout distance is calculated. Therefore, if the altitude profile is not flat when compared to the total length of the route, the calculated route distance is too short. The commonly implemented solution of ignoring the altitude information in distance calculation only works as long as the altitude variation is not large when compared to the total length of the route.

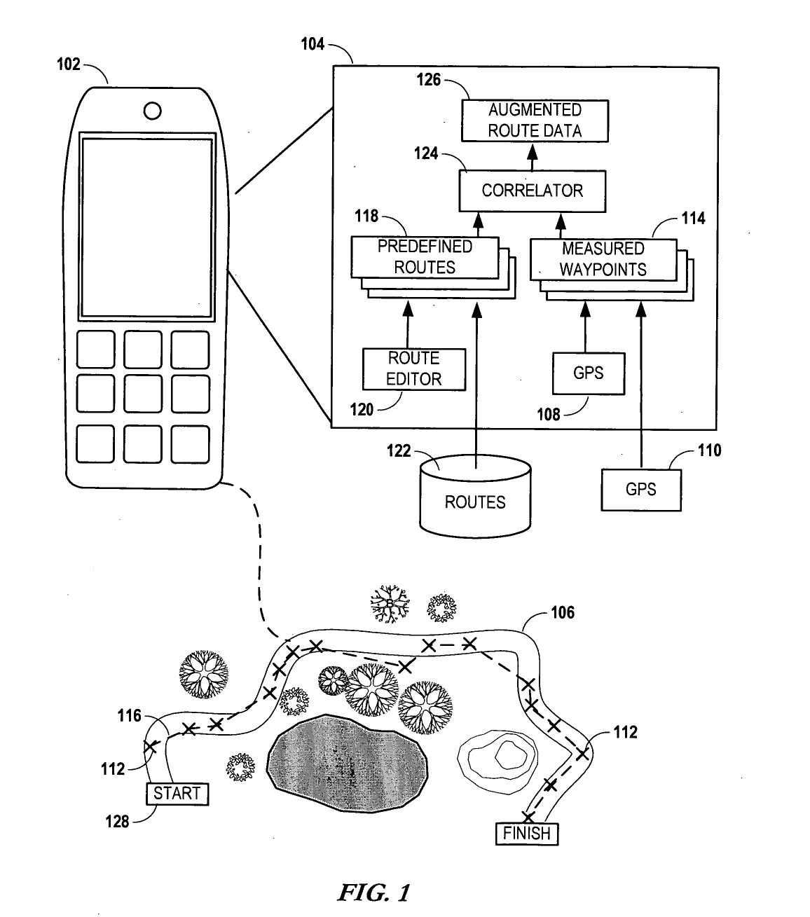

Therefore, to correct for missing or erroneous location measurement data, the present invention utilizes predefined path data to augment the measured data. The predefined path data can account for erroneous or missing location data, and produce augmented data with these errors corrected. The predefined path can also help the GPS start more quickly (e.g., a “warm start”) because an approximate current location can be determined based on the path points. The predefined path data can provide other benefits, such as providing supplemental metadata that can be associated with the augmented data. An example of how this can be accomplished is shown in FIG. 1.

The diagram in FIG. 1 illustrates an example of route-assisted GPS tracking according to an embodiment of the invention. A mobile terminal 102 (here shown as a cellular phone) includes a route assisted GPS tracking arrangement 104 that may include hardware and software components. A user carries the terminal 102 when traversing a path 106. The terminal 102 may include an integrated GPS sensor device 108 and/or interface with an external GPS device 110. The terminal 102 records a number of waypoints 112 and stores the readings as data 114 on the device. The data 114 may include a latitude, longitude, elevation, time, and quality of location fix for each of the points 112. In another arrangement, the external device 110 is carried with the user and the device 110 records the data in its own memory. Later (e.g., after the workout) the data is then transferred from the device 110 to the terminal 102, where it can be processed as described further hereinbelow.

As can be seen in the illustration, the waypoints 112 are overlaid on the path 106, showing that there may be some errors and missing data. The measured data 114 will also likely include time errors, although for many applications, those errors may be considered negligible. Because the GPS device 108, 110 may not have had clear reception during the entire time of recording, various sections of the path 106 may have been traversed without any waypoints being recorded. The resulting measured path 116 (indicated by dashed lines) cannot account for these missing waypoints, and as a result the measured path 116 may contain significant errors.

To account for these errors in the measured path 116, the terminal 102 may include one or more predefined routes 118. The predefined routes 118 are accurate representations of known routes, including path 106. The predefined routes 118 may be created by the user using a route editor 120 that resides either on the terminal 102 or some other computing arrangement. The user may also have measured some of the route data 118 using this or another device, and verified the accuracy of the data. The predefined routes 118 may also be downloaded from an authoritative database 122. The database 122 may include human-created routes as well as routes that are automatically generated by computers based on authoritative reference data.

A correlator component 124 uses the predefined routes 118 and the measured data 114 in order to create augmented data 126. The augmented data 126 may include a series of times and associated waypoints based on the measured data 114, but corrected for location errors based on the more accurate predefined route data 118. The augmented data 126 may account for missing points in the measured data 114. For example, assume in FIG. 1 that the user started the path at start point 128, and the start time was recorded. However, the first waypoint 112 was not measured until a later time, so without knowledge of the route 106 defined in the route data 118, the system would have no way of knowing what distance was traversed from the start time to the time when the first waypoint 112 was measured.

As described above, the collection and augmentation of data need not occur on the same device. For example, the external device 110 may include at least a GPS sensor with local storage (e.g., flash memory). After the workout, the device 110 transfers the data to the terminal 102 for processing. As part of this process, the terminal 102 may also upload route data 118, 122 to the device 110 so that the device 110 can apply future route corrections on its own. In another arrangement, the device 110 may be a GPS device (e.g., a wristwatch type device) that contains a display and some “intelligence.” The display can be used to provide real-time exercise data to the user. In such an arrangement, the external device 110 could continuously send the measured locations 114 to terminal 102 (or any other networked computing arrangement) for further processing, such as via a short or mid range wireless data connection. The terminal 102 could process the data 114 via the correlator 124, and send back augmented data 126 to the external device 110 so that data shown on the device 110 during the workout is corrected in near real time by the terminal 102. Alternatively, the terminal 102 may be able to select the correct route data 118 based on initial points 114 transmitted from the external device 110, and the external device 110 performs its own corrections, such as via correlator-type program running on the device 110.

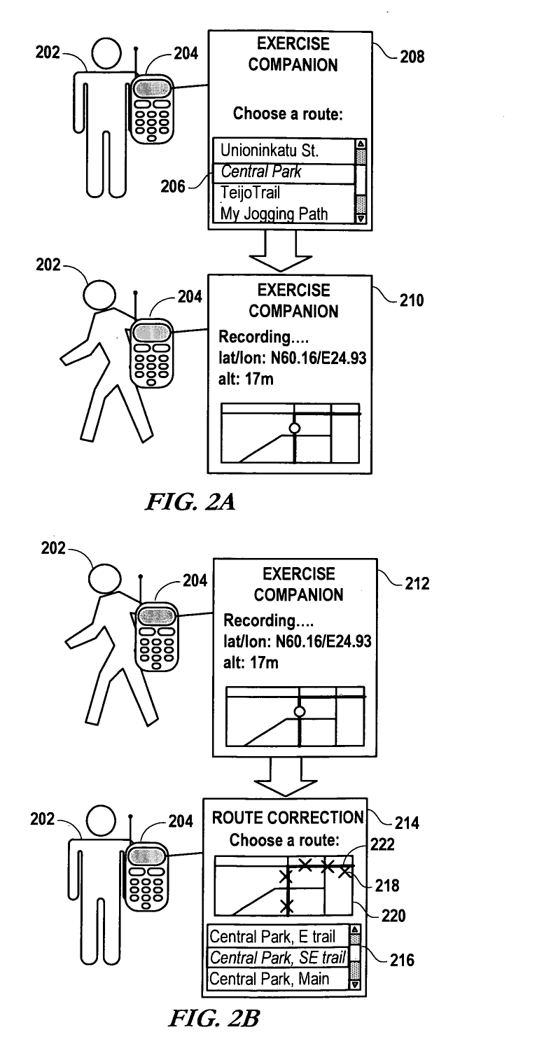

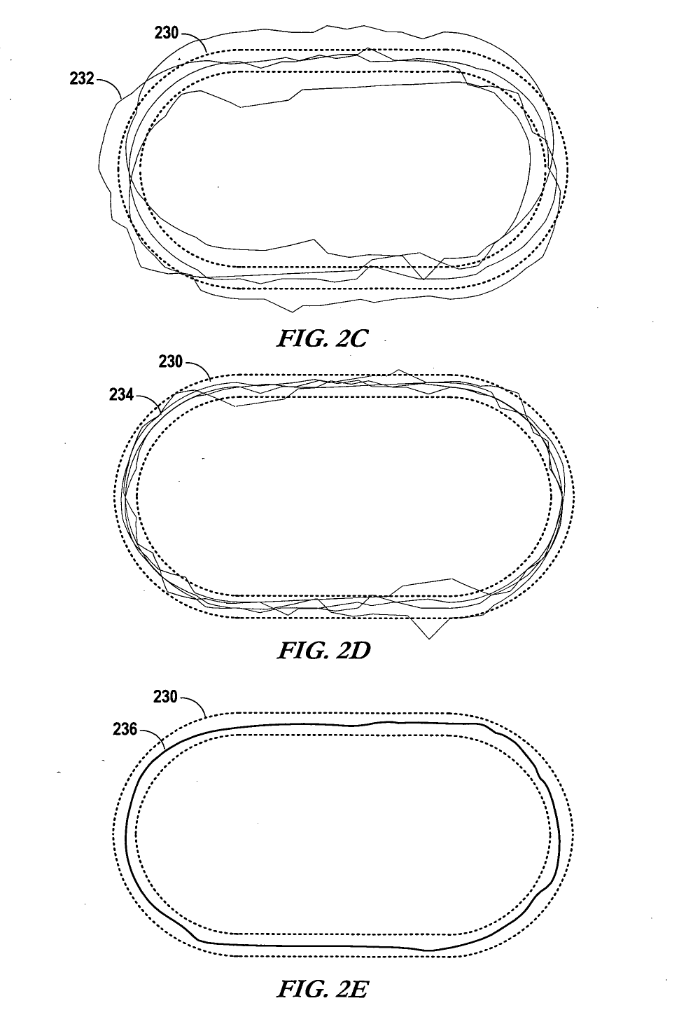

In reference now to FIG. 2A, an example sequence is illustrated for assisted path and workout data recording according to an embodiment of the invention. A user 202 of a GPS-enabled mobile terminal 204 selects a route 206 via interface 208 before starting to record a workout. The routes 206 could be arranged and stored based on user preferences. In another example, the route selection process could be automated or augmented by utilizing secondary location data (base station ID etc.) related to routes and available to the terminal. For example, when the user is in cellular network cell A and there are routes also located in A, the system could select the routes automatically or prioritize them in the selection user interface 208.

The selected route 206 may be stored as an ordered set of location points. The actual shape of the route 206 can be determined from these points using techniques known in the art, including linear interpolation, polynomial interpolation, spline interpolation, etc. In addition to the location information, each location point may also contain information about the quality of location fix, if the route data was measured using a GPS device.

The route 206 can be created in numerous ways. The route may have been previously recorded by the user, received from a friend as a file or in other ways, downloaded from a dedicated service, created manually with a phone/PC, etc. In any of these cases, the user 202 can be provided the ability to manually modify the resulting route 206 using the terminal 204. This can be useful if the part of the previously recorded workout location data is noticeably inaccurate, or if the user wants to create a route that is partly different compared to the previously recorded workout. For example, the user may wish to select different starting and ending points on an existing route.

After the route is selected, the user 202 starts moving with the mobile terminal 204. The terminal 204 begins recording the workout, as indicated by display 210. Based on the previously selected route 206, the system knows, or assumes, the initial location of the user 202. This location information can be given as an input for the GPS device 204, which can use this information to reduce the time-to-first-fix. Based on the selected route 206 and starting position within that route, the user can start workout recording immediately without waiting for the GPS device to get a first location fix. When the GPS device 204 gets a location fix, the missing part of the location information from the beginning of the workout can be filled with route information. Based on the filled-in information, the traveled distance can be corrected. With time information and correct distance, average speed for the missing part can be calculated.

In the example of FIG. 2A, the route 206 is selected before the user 202 begins to move. An alternate sequence of route correction according to an embodiment of the invention is shown in FIG. 2B. Generally, the user 202 begins moving with the device 204 recording, as indicated by screen 212. The GPS device 204 records the waypoints as described above. Later, the user 202 may discover that the recording has errors, such as missing waypoints or significantly erroneous waypoints. The user 202 can thereafter use a route correction utility as indicated in screen 214 to correct the errors.

The route correction utility 214 can select one or more known routes 216 based on the previously recorded waypoints (indicated by marks 218 on the map display 220). Each selected route 216 may be overlaid on the map 220 such as indicated by bold line 222, to enable the user to visually judge which routes 216 are appropriate. The user 202 may have other tools to modify selected routes, such as being able to define start and end points, combine and split routes 216, etc. The routes 216 may be selected from previously saved data created or measured by the user. Alternatively, the routes 216 may be determined from a remote source. For example, the waypoints 218 may be used as input to a search engine, and the routes 216 are returned as a result of the search based on a fit between the waypoints 218 and the routes 216.

The correction of errors via the route correction utility 214 may involve replacing the originally recorded data. However, because the data likely takes up minimal space in memory, the original recording preferably stored in its original state after the correction/augmentation is applied. This enables the user to rerun the corrections/augmentation in case more accurate reference route becomes available or if the user accidentally applied a wrong reference route. The original data may have other uses, such as device troubleshooting, calibration, and may have other useful data (e.g., proprietary additions, hardware data) that is useful aside from location measurement uses.

It will be appreciated that combinations of the sequences shown in FIGS. 2A and 2B may be used in a terminal 204 according to embodiments of the invention. Further, the determination of routes 206, 216 and subsequent corrections/augmentations may occur automatically or manually, and may be determined before, after, or during any recording activity by the terminal 204. For example, the terminal 204 may be enabled to detect GPS dropouts, and automatically connect to a wireless network to obtain route data based on already recorded waypoints in response to the dropout detection. This route data is then used to augment the measured data while it is being recorded. In another example, the route data 206, 216 may be used to add metadata (e.g., place name annotations) to the data in real-time as it is being recorded.

As described above, route data may be obtained from numerous sources. One option is to obtain independently gathered and verified data from a third-party. However, such data may not always be available, and the user may want to have ways of compiling their own route data. An example of how accurate route data can be created using GPS measurements according to an embodiment of the invention is shown in FIGS. 2C-2E. In FIG. 2C, boundaries of a path 230 is represented by broken lines. The width of the path 230 relative to its length may be somewhat exaggerated in this figure in order to enhance clarity. In typical applications, the path 230 may not have a substantial width in comparison to its length.

A number of measurements sets 232 are shown overlaid with the path 230. These measurements 232 are created by the user who carries a GPS enabled device while traversing the path 230. The measurements 232 may exhibit both constant errors (e.g. the entire shape is shifted by a constant distance vector) and random errors (e.g., causing the “roughness” of the shape). However, if these errors are (at least somewhat) randomly distributed, an optimal route that deviates less from the actual path 230 traveled can be calculated by combining multiple measurement sets as shown in FIGS. 2D and 2E. In FIG. 2D, a normalized measurements 234 are shown that are obtained by geometrically translating the original measurements 232 so that the difference between the routes is minimal. For example, a centroid of each set of the original measurements 232 could be calculated, and then each set is translated so that all of the centroids are on the same point, thus forming the normalized measurements 234. Combined translation of the routes should be zero so that they become centered. GPS precision information may also be used in determining the translations of the routes. The translation removes the GPS inaccuracies that may be specific to each route.

In reference now to FIG. 2E, an average route 236 is shown that is calculated based on the normalized routes 234 using well-known mathematical methods. These methods may involve, for example, plotting all of the points as polylines or curves, and numerically averaging respective points at predefined intervals along the curves. In another configuration, all of the location the points can be fitted to a polyline or curve (e.g., least squares fit), where the curve represents a nominal representation of all of the data. These techniques may also involve discarding values having the largest deviation from the average or fit (or use some other method of determining outliers) and calculating the average from rest of the values. The GPS accuracy information, such as the number of satellites, and the altitude information associated to the location points of the routes, may also be used in the calculation, particularly in discarding outliers. It will be appreciated that in the calculations described in relation to FIGS. 2C-2E, that the accuracy of latitude and longitude information is typically better than altitude accuracy, particularly when the measurements are made solely via GPS.

The route corrections described above can be implemented so that the resulting route 236 is recalculated every time the user traverses the path 230, thereby constantly improving the accuracy the measurement, or at least increasing the confidence level of estimated error. In such an implementation, if the route traveled by the user changes permanently, the system may be configured to adaptively take into account the new route. This can be achieved by giving recent workouts more weight when calculating the route. In case of abrupt changes (e.g., roadwork forcing the user to change the route), the user could be consulted to make the decision whether or not the change was real of because of erratic data from the positioning device. This feature can be also utilized in removing outlier data automatically during the recording.

The workout route data 230 can be shared to a dedicated service to utilize it to perform location information correction. The service may be located on the mobile GPS and/or terminal device, on a separate user device (e.g., home computer), or be accessible via a network. If all or part of the user's workout data history is stored in the service, the correction can be made in the service in real time during the workout recording. This reduces significantly the need of computational power and memory requirements in the user's mobile terminal and/or GPS device. Also more advanced and computational complex methods can be utilized in the service side for corrections while still allowing for near real time correction.

Although the term “route” and “path” generally refer to some collection of points that do not vary over time, it will be appreciated that the user may intentionally or unintentionally alter some aspects of the path. For example, a path may have a fork where the user randomly takes the left or right fork, and the forks rejoin at some later point. Another example is where the user takes different starting points on a circuitous route, so that the same shape is eventually traversed, but the start and stop points are different. Systems as described herein may therefore assume that some routes represent as unique workout routes may be partially adjacent/overlapping to some other routes. In that case, the information describing adjacent/overlapping portions of one route can be used for partially correcting those other routes that share those adjacent/overlapping portions.

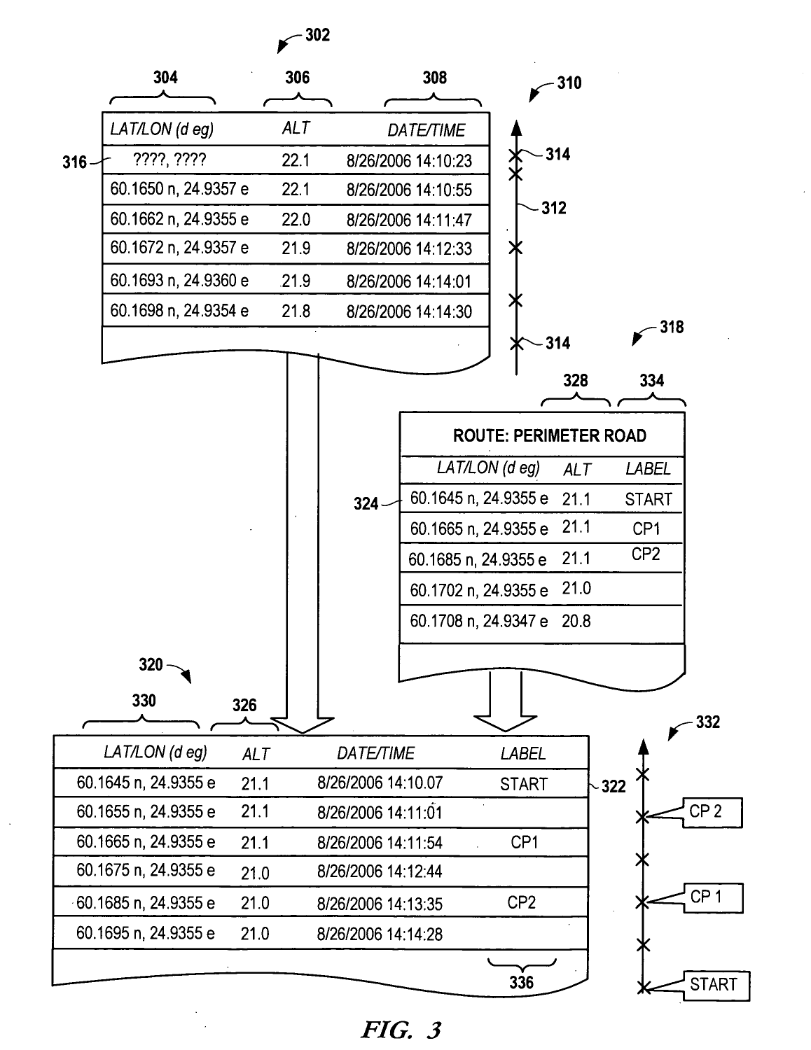

There are numerous ways that measured location data may be augmented using route data. In reference now to FIG. 3, an example is illustrated of creating augmented location data according to an embodiment of the invention. Data set 302 represents location data measured for a particular user activity. The data measured in this example includes lat/lon waypoints 304, altitude 306, and date/time 308. Many other types of measured data may relevant and added to this data set 302, including satellite signal strength, estimate of location measurement errors, temperature, heart rate, breathing rate, wind, etc. Generally, however, the lat/lon 304 and altitude 306 are the two types of data that are generally corrected/augmented using route data, although other data, such as signal strength and estimated error, may also be useful in the augmentation process.

Also illustrated adjacent to the data set 302 is an example path diagram 310 that roughly corresponds to the measured points of the data set 302. The line 312 of the path illustrates the “true” path taken, and the marks 314 represent the measured data points 302. Note that the first measured data point 316 does not have a lat/lon value, indicating the location sensor apparatus had not yet gotten an initial fix. As a result, there is no mark 314 at the origin of the line 312. Also note that the marks 314 are not dispersed evenly over the line 312, thus reflecting that the location measurements 304 may have been made intermittently.

A data processing arrangement according to an embodiment of the invention may use route information 318 and measured data 302 as described herein to produce augmented data 320. Generally, augmented data 320 refers to an altered set of the measured data 302. This alteration may include any combination of correcting existing data points for errors, subtracting superfluous or clearly erroneous data, adding additional data points, and adding other data that is descriptive of the original or corrected data points.

For example, the illustrated augmented data set 320 includes an extrapolated starting point 322 that is derived from both the starting time 316 of the measured data 302 and the starting location 324 of the route data 318. Additionally, the altitudes 326 of the augmented data 320 are changed to reflect the altitude data 328 of the route data 318. This assumes the route data altitudes 328 are known to be more accurate than the measured altitudes 306, such as where the route data altitudes 328 are derived using very accurate surveying equipment. Also, altitude data is more likely to be unavailable than location data because it requires usable signals from four satellites, yet changes in elevation are very important in measuring the intensity of physical activities and in correctly calculating distances. Therefore external sources of altitude/elevation data may be particularly useful in augmenting measured data.

In another example of changes made to the augmented data 320, the lat/lon values 330 may also have corrections applied, and then interpolated to create evenly spaced points. One way of doing this is to overlay the measured lat/lon data points 304 onto a curve that models the route data 318. The corrected points may be defined as points lying on the curve that are closest to the measured points. This is found geometrically by drawing a line between the measured points 304 and the curve, where the line is made perpendicular to the curve. The intersection of this perpendicular line with the curve represents the location of the corrected point.

After the corrected points have been determined, the time associated with each corrected point can be used to estimate such values as velocity and acceleration along the route. With at least the estimated velocity values, an interpolation may be applied at evenly spaced points, as seen in the augmented path diagram 332. This even spacing may be applied by using uniform steps of either time or distance. In situations where the measured data 302 has sufficiently high granularity, there may be no need to interpolate points, although at least a correction for errors may still be useful.

Another type of modification that may be applied to the augmented data 320 involves adding metadata that cannot typically be measured by a device. In this example, the route data 318 includes checkpoint names 334 that may correspond to inherent features of the route (e.g., start, mid, end points), particular data points of interest to the user (e.g., mile/kilometer points, peaks of hills), and other data (e.g., place names, points of interest). These names are added to the augmented data 320, as indicated by column 336. Because the illustrated augmented data 320 is extrapolated and interpolated from the measured data 302, it is fairly simple to add additional points (if needed) to correspond to the checkpoints, and then add the labels 336 to those points. Alternatively, where there is no interpolation, the labels 336 can be added to the nearest appropriate data point. Also note that these labels are shown applied to the augmented path diagram 332.

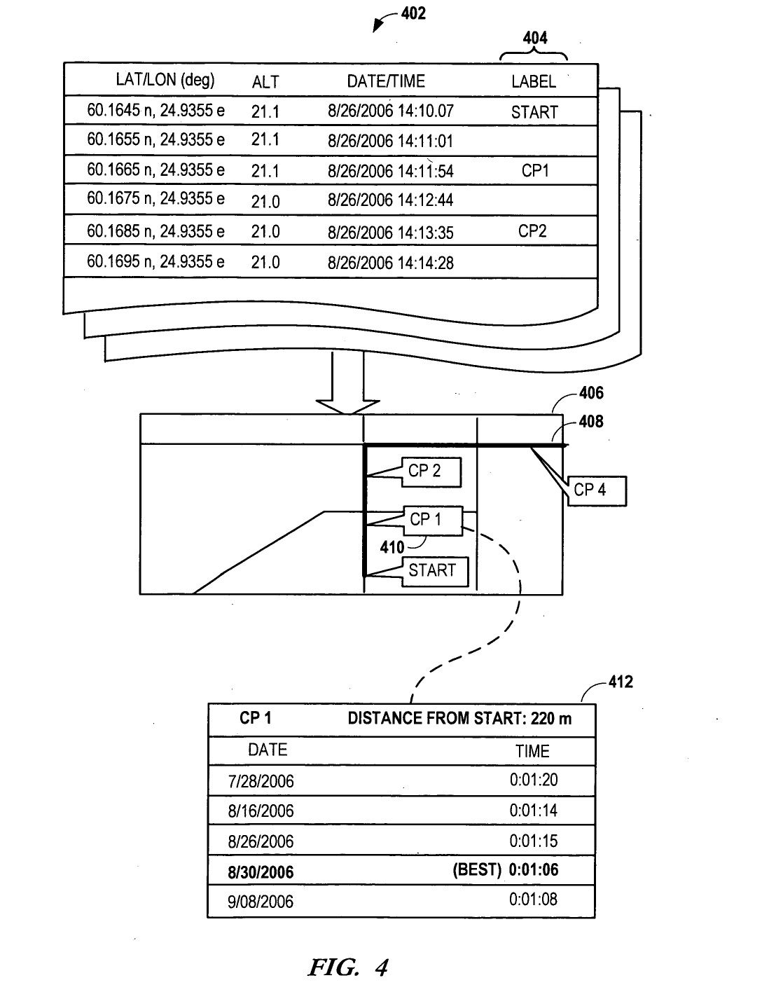

One advantage in using evenly interpolated augmented data points and/or labels is that the augmented data from multiple exercise/sports sessions can be easily compared by the end user. This is shown in FIG. 4, which illustrates a historical readout of augmented data according to an embodiment of the invention. In this example, the user of location-sensing mobile terminal has repeatedly traversed a route and taken measurements along that route. These measurements have been converted to a plurality of augmented route data sets 402. These data sets 402 may have been interpolated and/or extrapolated so that, for each discrete location along the route, each set 402 will have a data point corresponding to that location. Alternatively, the data sets 402 may have sufficiently fine measurements (e.g., close together in distance and/or time) that negligible error occurs from picking the nearest point to the point of interest.

The illustrated data sets 402 include annotations 404 of checkpoints or other points of interest. The annotations 404 may have been automatically added as part of the augmentation process, or may be dynamically determined and associated with the appropriate data points whenever the underlying data sets 402 are accessed. The annotations 404 can be displayed on a two-dimensional (or three-dimensional) map 406 that shows the route 408. The annotations 404 can be represented on the map as links, labels and the like, as exemplified by label 410. The label 410 may be selectable, and in response to being selected, historical data 412 related to the labeled point of interest is presented.

In the illustrated example, the label 410 represents a checkpoint along the route 408 and the historical data 412 shows the time it took the user to reach that checkpoint at various dates when the route was traversed. In this way, the user can see whether improvements are being made over time at different phases of the workout. Other data may also be captured with the location data sets 402, such as heart rate, breathing rate, calories burned, temperature, wind, etc. Not all of the data need by captured by the user device that collected the location data 402. For example, there may be a weather station nearby to the route 408, and data such as air temperature, precipitation, wind, etc., can be gathered from the weather station. This data may be remotely accessible by a user device, such as by using a Web service accessible via the Internet. This type of data may be gathered in near real time when the route is traversed, or at some later date.

Another use of evenly interpolated data is in creating display charts that display the distance measured along the reference route on the horizontal axis and the (interpolated) speed at those points on the vertical axis. In this way, measurements of different recordings are aligned the so that each speed value corresponds to the speed measured in the same geographical location. By interpolating to corrected distances based on accurate route data, the speed values are much better aligned with the actual distance than if the speeds were aligned with the originally recorded distance data. This is because recording errors in geographic location cause cumulative errors in distance calculations. Therefore, elapsed distance measurements may particularly benefit from the correction and interpolation of route data, particularly towards the end of the route.

The placing of data 402 in a common format may also useful for situations where different routes are to be compared. For example, the user may regularly traverse a wide variety of routes over a period of time, and wishes to know the first 500-meter times for all of the routes. This data could be presented with other data, such as change in elevation/slope along each segment, wind speeds and directions, etc., that may be different for each route segment that is compared.

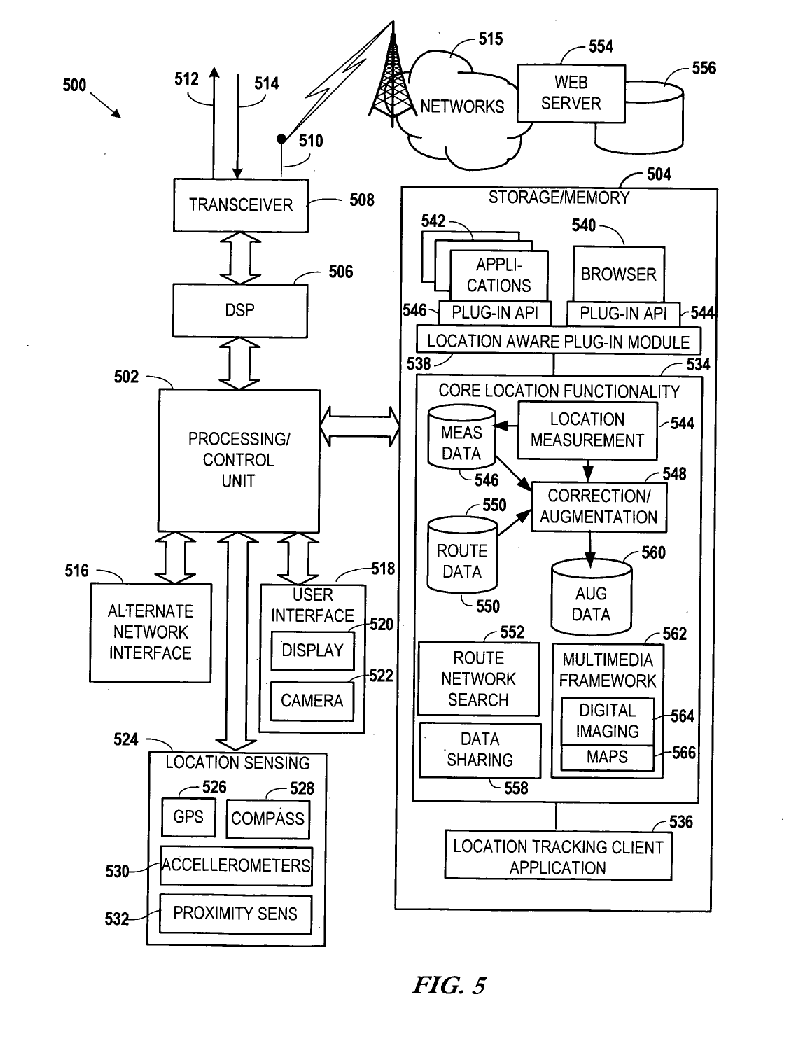

Many types of apparatuses may be able to provide route-assisted location detection as described herein. Mobile devices are particularly useful in this role. In reference now to FIG. 5, an example is illustrated of a representative mobile computing arrangement 500 capable of carrying out operations in accordance with embodiments of the invention. Those skilled in the art will appreciate that the exemplary mobile computing arrangement 500 is merely representative of general functions that may be associated with such mobile devices, and also that landline computing systems similarly include computing circuitry to perform such operations.

The processing unit 502 controls the basic functions of the arrangement 500. Those functions associated may be included as instructions stored in a program storage/memory 504. In one embodiment of the invention, the program modules associated with the storage/memory 504 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 500 via data signals, such as being downloaded electronically via one or more networks, such as the Internet and an intermediate wireless network(s).

The mobile computing arrangement 500 may include hardware and software components coupled to the processing/control unit 502 for performing network data exchanges. The mobile computing arrangement 500 may include multiple network interfaces for maintaining any combination of wired or wireless data connections. In particular, the illustrated mobile computing arrangement 500 includes wireless data transmission circuitry for performing network data exchanges.

This wireless circuitry includes a digital signal processor (DSP) 506 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 508, generally coupled to an antenna 510, transmits the outgoing radio signals 512 and receives the incoming radio signals 514 associated with the wireless device. These components may enable the arrangement 500 to join in one or more networks 515, including mobile service provider networks, local networks, and public networks such as the Internet.

The mobile computing arrangement 500 may also include an alternate network/data interface 516 coupled to the processing/control unit 502. The alternate network/data interface 516 may include the ability to communicate on secondary networks using any manner of data transmission medium, including wired and wireless mediums. Examples of alternate network/data interfaces 516 include USB, Bluetooth, Ethernet, 802.11 Wi-Fi, IRDA, etc. These alternate interfaces 516 may also be capable of communicating via the networks 515.

The processor 502 is also coupled to user-interface elements 518 associated with the mobile terminal. The user-interface 518 of the mobile terminal may include, for example, a display 520 such as a liquid crystal display and a camera 522. Other user-interface mechanisms may be included in the interface 518, such as keypads, speakers, microphones, voice commands, switches, touch pad/screen, graphical user interface using a pointing device, trackball, joystick, etc. These and other user-interface components are coupled to the processor 502 as is known in the art.

Other hardware coupled to the processing unit 502 includes location sensing hardware 524. Generally, the location sensing hardware 524 allows the processing logic of the arrangement 500 to determine absolute and/or relative location and orientation of the arrangement. The location may be expressed in any known format, such as lat/lon and UTM. The orientation may also be expressed using angles of a component of the arrangement (e.g., lens of the camera 522) relative to known references. For example, pitch and roll measurements may be used to define angles between the component and the earth's surface. Similarly, a heading measurement may define an angle between the component and magnetic north. The location sensing hardware 524 may include any combination of GPS receivers 526, compasses 528, accelerometers 530, and proximity sensors 532, and any other sensing technology known in the art.

In typical embodiments, the location sensing hardware 524 will at least include the GPS receiver 526, as such devices can be included at fairly low cost, and do not require any additional infrastructure other than the currently deployed satellite constellation. The location sensing hardware 524 may be integrated into the hardware packaging of the arrangement 500, or may be an add-on or peripheral device. For example, an external Bluetooth capable GPS receiver 526 may be capable of being data coupled to (and possibly physically integrated with) the arrangement 500 for purposes of providing location sensing functions described herein.

The program storage/memory 504 typically includes operating systems for carrying out functions and applications associated with functions on the mobile computing arrangement 500. The program storage 504 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 504 of the mobile computing arrangement 500 may also include software modules for performing functions according to embodiments of the present invention.

In particular, the program storage/memory 504 includes a core functionality module 534 that provides some or all of the location-aware client functionality as described hereinabove. The core functionality 534 may be used by a standalone location-aware client application 536. The core functionality 534 may also be included as a location-aware plug-in module 538. The plug-in module 538 may be used to extend the functionality of other applications such as a browser 540 or other applications 542. These applications 540, 542 have respective generic plug-in interfaces 544, 546 that allow third parties to extend the functionality of the original application 540, 542.

The core functionality module 534 includes a real-time or near-real-time location measurement module 544 that is capable of measuring locations of the arrangement 500 via the location sensing hardware 524. The location measurements may stored in a measurement database 546 for later access. An augmentation/correction module 548 (also referred to herein as a correlation module) is capable of conditioning the measured data 546 by way of comparing the data 546 to authoritative route data 550. This augmentation may include correcting erroneous readings, filling in missing readings through interpolation/extrapolation, adding descriptive metadata to particular measurements, placing the measurements in a common format and spacing between data points, etc. The augmentation/correction module 548 may also present user controls via user interface 518 so that the user can apply augmentations and corrections manually. These manual operations may occur either before or after automatic corrections are applied by the module 548, or may forgo the need for automatic corrections by the module 548.

The route data 550 may be created by the user of the device 500, such as by manually entering points or using previously captured data. The location tracking application 536 may be able to assist in this data creation, such as by presenting a user interface for creating and managing the routes. The routes may also be created externally, such as on a desktop computer or via a different measuring device. In such a scenario, the location tracking client 536 may assist in downloading, verifying, and storing such externally created data on the device 500.

Another way that route data 550 may be created is by third parties. Large-scale, publicly-accessible networks such as the Internet enable people around the world to contribute data on any subject. Route data 550 may be similarly made public and freely exchanged, such as via placement on a Web server 554 and database 556 that are accessible from public networks 515. As such, the core functionality 534 may include a route search tool 552 that is capable of locating route data via the networks 515. The browser 540, applications 542, and location tracking application 536 may be similarly employed to search for and retrieve route data 550 via networks 515. Similarly, the user may wish to share the route data 550 that they have collected or created, and this may be accomplished by way of a data sharing interface 558. The data sharing interface 558 may access and format the route data 550, and facilitate sharing of the data via networks 515, such as by uploading the data 550 to the Web server 554 and/or database 556.

The augmentation/correction module 548 may use the measured data 546 and route data 550 to form augmented data 560 that is a corrected, annotated, and/or normalized version of the measured data 546. This augmented data 560 can be used to track performance of a particular session, or to compare multiple sessions over time, such as historical performance comparison. This data 560 may also be shared with other enthusiasts, such as by uploading some of the data 560 to elements 554, 556 of publicly accessible networks 515 via the data sharing interface 558.

The user may also wish to view the augmented data 560 in a graphical form, and this may be accomplished by way of a multimedia framework module 562. This module 562 may include such capabilities as a digital imaging component 564 that renders augmented data 560, route data 550, and/or measured data 546 on the display 520 in two-dimensional and three-dimensional views. The multimedia framework 562 may also include maps 566 that can be placed in the background of rendered data. The multimedia framework 562 may also assist in other aspects of the core functionality 534. For example, the digital imaging component 564 may be able to access digital photos taken via the camera 522 and associate those photos with measured position data 546, route data 550, and/or augmented data 560. This gives the users a more complete record of their workouts and travels, and enriches the sharing experience via the network entities.

The mobile computing arrangement 500 of FIG. 5 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

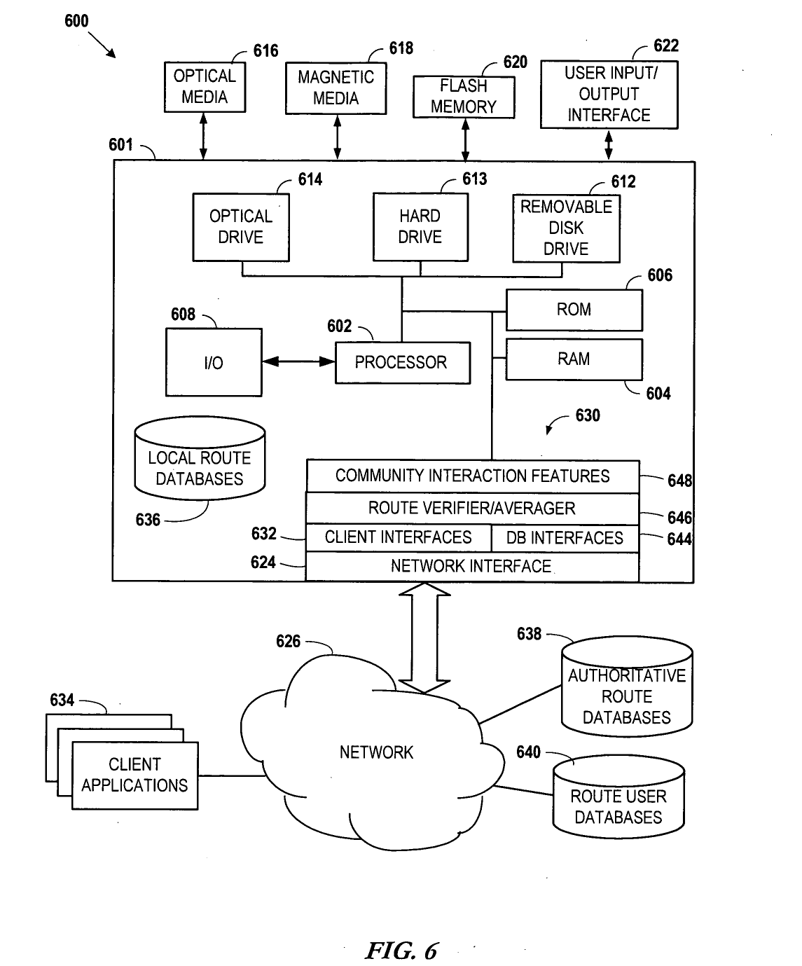

As described above, the location monitoring applications maybe able locate accurate route data and related sports/exercise data of interest using standard search engine techniques. However, a more complete and accurate database of objects and associated locations can be obtained by providing specialized databases that associate the locations with pre-prepared data, and allow a community to add to and modify that data. One way to do this, as described hereinabove, is to provide one or more network service components that centralize and standardize various types of location-referenced data. For example, a specialized search engine may be able to parse latitudes and longitudes taken from measured data, and produce a number of known routes that are formatted to assist in producing augmented data as described herein. In reference now to FIG. 6, an example computing structure 600 is shown that may be suitable for providing specialized location-aware services according to embodiments of the present invention.

The computing structure 600 includes a computing arrangement 601. The computing arrangement 601 may include custom or general-purpose electronic components. The computing arrangement 601 includes a central processor (CPU) 602 that may be coupled to random access memory (RAM) 604 and/or read-only memory (ROM) 606. The ROM 606 may include various types of storage media, such as programmable ROM (PROM), erasable PROM (EPROM), etc. The processor 602 may communicate with other internal and external components through input/output (I/O) circuitry 608. The processor 602 carries out a variety of functions as is known in the art, as dictated by software and/or firmware instructions.

The computing arrangement 601 may include one or more data storage devices, including removable disk drives 612, hard drives 613, optical drives 614, and other hardware capable of reading and/or storing information. In one embodiment, software for carrying out the operations in accordance with the present invention may be stored and distributed on optical media 616, magnetic media 618, flash memory 620, or other form of media capable of portably storing information. These storage media may be inserted into, and read by, devices such as the optical drive 614, the removable disk drive 612, I/O ports 608 etc. The software may also be transmitted to computing arrangement 601 via data signals, such as being downloaded electronically via a network, such as the Internet. The computing arrangement 601 may be coupled to a user input/output interface 622 for user interaction. The user input/output interface 622 may include apparatus such as a mouse, keyboard, microphone, touch pad, touch screen, voice-recognition system, monitor, LED display, LCD display, etc.

The computing arrangement 601 may be coupled to other computing devices via networks. In particular, the computing arrangement includes a network interface 624 for interacting with client and server entities via a network 626. The network interface 624 may include a combination of hardware and software components, including media access circuitry, drivers, programs, and protocol modules.

The computing arrangement 601 includes processor executable instructions 630 for carrying out tasks of the computing arrangement 601. These instructions include client interfaces 632 capable of communicating with client applications 634 for purposes of exchanging route data, including data that is both automatically collected and manually entered. The client interfaces 632 are generally capable of receiving route search queries from the client applications 634, delivering search results in the form of route data to the applications 634, managing authentication and identities, etc. The client interfaces 632 may interface with a local route database 636 and one or more remote databases 638, 640 via a database interface 644. The clients 634 may store, retrieve, view, and/or modify data stored in these databases, 636, 638, 640 including route data, measured location data, route annotations, etc.

The local route database 636 may be a specialized database having data in formats and relationships uniquely suited to the client applications. The other databases 638, 640 may have similar or different formats. Where the formats are different, the database interface 644 may perform translation between the respective formats of the local database 636 and the authoritative and user databases 638, 640. The authoritative route database 638 may include route data created by government or corporate entities for various purposes. For example, results of a government survey of an area may include high-precision location data that is useful as route data. The user databases 640 may include data contributed from various individuals or groups, and may be in the form of a file server (e.g., FTP/HTTP), Web log (“blog”), or some other remotely accessible data service.

Although one purpose of the computing structure 600 is to provide easily locatable, properly formatted route data, other local server applications may also interface with clients 634 and databases 636, 638, 640 to enhance the experience. For example, a verifier/averager component 646 could be used to improve the accuracy of publicly submitted routes. For example, if ten different people measure the same route with different equipments, those measurements could be combined in order to determined the measurement error and possibly improve estimates of the actual route coordinates based on averages of the submitted values. Additionally, outlier data could be rejected, further improving accuracy of the route data. The component 646 could also perform other verifications of submitted routes, such as comparing them against known map data. This verification could be coarse, such as ensuring the coordinates all lie within a rectangle where the route is known to lie, or could include checks on a finer scale, such as by checking size, shape, comparison to local features where locations are known, etc.

Another application 648 may be used to provide community interaction features. For example, people could post route data and descriptions of a little known or newly found route that they use. These postings could be augmented using camera pictures taken while traversing the route, weather data, etc. Users could also post their own measured data taken while exercising in the routes. Based on this posted measured data, users could compare their route completion times with others who are using the same route, and possibly those who are using the same type of client application 634. In order to make sure such posted data is not doctored, the client applications 634 and associated hardware may include features such as encryption that prevents measured data from being altered during or after it is collected, so that any posted measurement data has some level of trustworthiness.

The computing structure 600 is only a representative example of network infrastructure hardware that can be used to provide location-based services as described herein. Generally, the functions of the computing structure 600 can be distributed over a large number of processing and network elements, and can be integrated with other services, such as Web services, gateways, mobile communications messaging, etc.

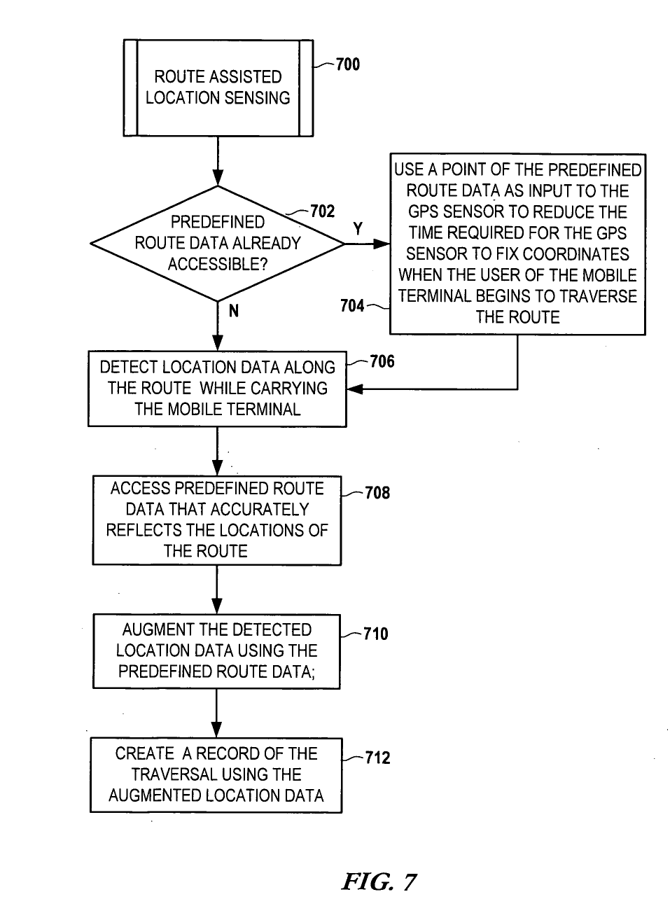

In reference now to FIG. 7, a flowchart illustrates a procedure 700 for route assisted location sensing on a mobile terminal equipped with a Global Positioning System (GPS) sensor. If it is detected 702 that predefined routed data for the current route is already accessible via the mobile terminal, a point of the predefined route data is used 704 as input to the GPS sensor to reduce the time required for the GPS sensor to fix coordinates when a user of the mobile terminal begins to traverse the route. Thereafter, location data is detected 706 along the route using when the user traverses the route while carrying the mobile terminal. Predefined route data is then provided 708 that accurately reflect the locations of the route. The detected location data is augmented 710 using the predefined route data, and a record of the traversal is created 712 using the augmented location data. The augmentation 710 can occur in real-time, near real-time, or after the fact. In any of these cases where data is corrected/augmented, the original recordings (e.g., at step 706) can be stored so that they can be later corrected/augmented 710 using a different reference route.

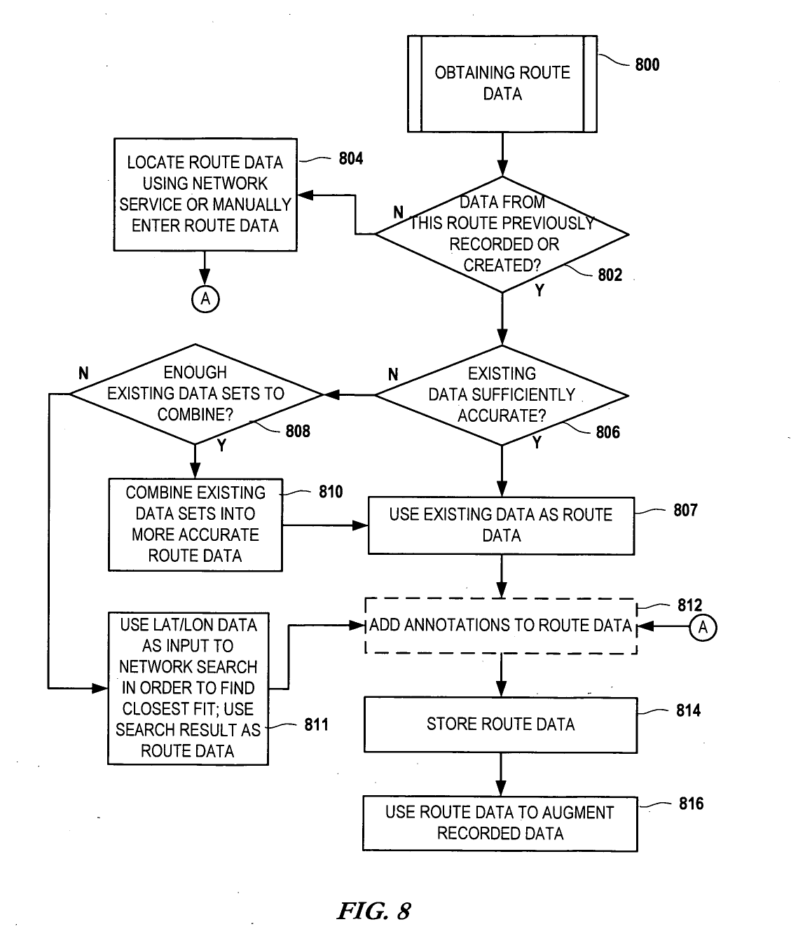

In reference now to FIG. 8, a flowchart illustrates a procedure 800 for finding suitably accurate route information according to embodiments of the invention. First, it is determined 802 whether the route data has been previously recorded via the device or otherwise created. If not, then the data is obtained 804 by creating the data manually or searching for it via a network source. If the data has been recorded, it should also be verified 806 to be sufficiently accurate for these purposes. If the data is sufficiently accurate, then it is used 807 as route data.

If not, or if suspect, the data may still be useful. If it is determined 808 that there are enough previously recorded data sets, the previously recorded data can be combined 810 into a more accurate set of data, upon which it can be used 807. If there is not enough previously recorded data to form a useful combination, the current location measurement can be input 811 into a generalized or specialized search function or mapping utility in order to find a close fit.

However the route data is determined, the user may optionally wish to add 812 annotations. In some cases, such as a network source, the annotations may already exist, however users may wish to add annotations that suit their own needs. The route data can then be stored 814 and used to augment 816 future (or previously) measured data.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

1. A method comprising:
detecting, via a Global Positioning System (GPS) sensor, location data along a route while a user traverses the route;
providing predefined route data that accurately reflects the locations of the route;
augmenting the detected location data using the predefined route data via a mobile terminal capable of interfacing with the GPS sensor; and
creating a record of the traversal using the augmented location data, wherein the record of traversal comprises an improved representation of the route than is represented by the detected location data.

2. The method of claim 1, further comprising using a point of the predefined route data as input to the GPS sensor to reduce the time required for the GPS sensor to fix coordinates when the user begins to traverse the route.

3. The method of claim 1, wherein augmenting the detected location data using the predefined route data comprises filling in missing location data.

4. The method of claim 1, wherein augmenting the detected location data using the predefined route data comprises correcting erroneous location data.

5. The method of claim 1, wherein augmenting the detected location data using the predefined route coordinates comprises adding supplementary data to the detected location data.

6. The method of claim 5, wherein adding the supplementary data to the detected location data comprises adding descriptive labels to the detected location data.

7. The method of claim 1, wherein detecting the location data is accomplished via the mobile terminal while interfaced with the GPS sensor.

8. The method of claim 1, further comprising creating the predefined route data via the mobile terminal.

9. The method of claim 8, wherein creating the predefined route data comprises measuring coordinates of the predefined route data using the GPS sensor.

10. The method of claim 9, wherein creating the predefined route data comprises combining a plurality of location data sets previously measured on the route using the GPS sensor.

11. The method of claim 10, further comprising updating the predefined route data with the location data measured each time the route is traversed with the GPS sensor.

12. The method of claim 11, wherein combining the plurality of location data sets comprises giving a higher weighting to the most recent location data measured while the route is traversed with the GPS sensor.

13. The method of claim 1, wherein the predefined route data is provided after the location data is detected along the route using the GPS sensor.

14. The method of claim 13, further comprising searching for the predefined route data via a network based on the location data using the location data as a search parameter.

15. The method of claim 1, wherein the detected location data is augmented while the route is being traversed.

16. An apparatus comprising:
a data interface capable of interfacing with a Global Positioning System (GPS) sensor;
a processor coupled to the data interface; and
a memory coupled to the processor, the memory including instructions that cause the processor to,
access location data detected along a route using the GPS sensor when a user traverses the route while carrying the GPS sensor;
access predefined route data that accurately reflects the locations of the route;
augment the detected location data using the predefined route data; and
create a record of the traversal using the augmented location data, wherein the record of traversal comprises an improved representation of the route than is represented by the detected location data.

17. The apparatus of claim 16, wherein the memory includes instructions that further cause the processor to use a point of the predefined route data as input to the GPS sensor to reduce the time required for the GPS sensor to fix coordinates when the user begins to traverse the route.

18. The apparatus of claim 16, wherein augmenting the detected location data using the predefined route data comprises filling in missing location data.

19. The apparatus of claim 16, wherein augmenting the detected location data using the predefined route data comprises correcting erroneous location data.

20. The apparatus of claim 16, wherein augmenting the detected location data using the predefined route coordinates comprises adding supplementary data to the detected location data.

21. The apparatus of claim 16, wherein the memory includes instructions that cause the processor to augment the detected location data using the predefined route data while the route is being traversed.

22. The apparatus of claim 16, wherein the memory includes instructions that further cause the processor to create the predefined route data using coordinates previously measured using the GPS sensor.

23. The apparatus of claim 22, wherein the memory includes instructions that cause the processor to combine a plurality of location data sets previously measured on the route using the GPS sensor to create the predefined route data.

24. The apparatus of claim 23, wherein the memory includes instructions that further cause the processor to update the predefined route data with the location data measured each time the route is traversed with the GPS sensor.

25. The apparatus of claim 24, wherein the memory includes instructions that cause the processor to give a higher weighting to the most recent location data measured while the route is traversed with the GPS sensor when updating the predefined route data with the location data.

26. The apparatus of claim 16, further comprising a network interface capable of being coupled to a network, and wherein the memory includes instructions that further cause the processor to search for the predefined route data via the network based on the location data using the measured location data as a search parameter.

27. The apparatus of claim 16, wherein the apparatus includes the GPS sensor.

28. The apparatus of claim 16, wherein the apparatus comprises a cellular phone.

29. A computer-readable medium having instructions stored thereon which are executable by a data processing arrangement capable of interfacing with a Global Positioning System (GPS) sensor for performing steps comprising:
accessing location data that is detected along a route via the GPS sensor when a user traverses the route while carrying the GPS sensor;
accessing predefined route data that accurately reflects the locations of the route;
augmenting the detected location data using the predefined route data; and
creating a record of the traversal using the augmented location data, wherein the record of traversal comprises an improved representation of the route than is represented by the detected location data.

30. The computer-readable medium of claim 29, wherein the steps further comprise using a point of the predefined route data as input to the GPS sensor to reduce the time required for the GPS sensor to fix coordinates when begins to traverse the route.

31. The computer-readable medium of claim 29, wherein augmenting the detected location data using the predefined route data comprises at least one of filling in missing location data, correcting erroneous location data, and adding supplementary data to the detected location data.

32. The computer-readable medium of claim 29, wherein the steps further comprise combining a plurality of location data sets previously measured on the route using the GPS sensor to create the predefined route data.

33. The computer-readable medium of claim 32, wherein the steps further comprise updating the predefined route data with the location data measured each time the route is traversed with the GPS sensor.

34. An apparatus comprising:
means for accessing location data along a route, wherein the data is gathered via a GPS sensor when a user traverses the route;
means for accessing predefined route data that accurately reflects the locations of the route;
means for augmenting the detected location data using the predefined route data; and
means for creating a record of the traversal using the augmented location data, wherein the record of traversal comprises an improved representation of the route than is represented by the detected location data.

35. The apparatus of claim 34, further comprising means for using a point of the predefined route data as input to the GPS sensor to reduce the time required for the GPS sensor to fix coordinates when the user begins to traverse the route.
